(19) United States
(12) Patent Application Publication
(10) Pub. No.: US 2002/0069298 A1
(43) Pub. Date: Jun. 6, 2002

(54) Mobile terminal having multiple personal information management functionality

(76) Inventors: Jorgen Birkler, Malmo (SE); Lars Novak, Lund (SE)

Correspondence Address: Brian D. Walker, Jenkens & Gilchrist, P.C., 1445 Ross Avenue, Dallas, TX, 75202-2799, US

(21) Appl. No.: 09/728,310

(22) Filed: Dec. 1, 2000

(51) Int. Cl. G06F 15/16

(52) U.S. Cl. 709/248; 709/204

(57) ABSTRACT

A mobile terminal includes transceiver circuitry for communicating with a PLMN network. A multiple PIM functionality module within the mobile terminal provides multiple versions of a PIM application enabling the mobile terminal to synchronize with a plurality of remote servers and provide multiple sets of data with respect to the PIM application.

### TECHNICAL FIELD

The present invention relates to personal information managements (PIM) applications, and more particularly, to a system and method for synchronizing multiple versions of a personal information management application with multiple remote servers.

### BACKGROUND OF THE INVENTION

Mobile terminals such as laptop computers, mobile telephones, personal data assistants and pagers have become common tools in modern society. Users of these devices utilize personal information management (PIM) applications such as an address books, calendars, or “to do” lists on their mobile terminals. These PIM applications were originally stand alone applications without synchronization to the outside world. As PIM applications further developed, the next generation of applications included the ability to synchronize with a personal computer. This process is referred to as local synchronization.

When using local synchronization, a user has a single version of a PIM application on a personal computer which is synchronized with a mobile terminal version of the PIM application. Since the synchronization is local, the mobile terminal version of the PIM application may only synchronize with a single PC. A need has arisen for a mobile terminal PIM application to be able to synchronize with multiple remote computing devices or servers. This need has arisen because of the ability of a PIM application to remotely synchronize with a number of Internet servers. Users now desire to synchronize a mobile terminal PIM application with several different remote servers. Presently this is not possible.

### SUMMARY OF THE INVENTION

The present invention overcomes the foregoing and other problems with a mobile terminal capable of synchronizing with multiple remote servers. The mobile terminal includes transceiver circuitry enabling the mobile terminal to communicate with a PLMN network. A multiple PIM functionality within the mobile terminal enables the mobile terminal to synchronize with multiple remote servers and provide multiple versions of data with respect to a single PIM application.

Using the multiple PIM functionality, a mobile terminal may first obtain synchronization between a first version of a PIM application within the multiple PIM functionality and a first remote server. The mobile terminal next obtains synchronization between a second version of the PIM application and a second remote server. Data from both the first and second remote servers may then be displayed by the mobile terminal.

### BRIEF DESCRIPTION OF THE DRAWINGS

A more complete understanding of the method and apparatus of the present invention may be obtained by reference to the following Detailed Description when taken in conjunction with the accompanying Drawings wherein:

FIG. 1 is an illustration of a mobile terminal including the multiple PIM functionality of the present invention communicating with a plurality of remote servers;

FIGS. 2a-2c illustrate the manner in which data may be displayed from multiple remote servers on a display of the mobile terminal; and

FIG. 3 illustrates a unified display of data from a plurality of remote servers on a display of the mobile terminal;

FIG. 4 illustrates a configurable unified display showing personal and general information;

FIG. 5 is a flow diagram illustrating the operation of the system illustrated in FIG. 1; and

FIG. 6 illustrates downloading of data between a pair of mobile terminals rather than from a remote server.

### DETAILED DESCRIPTION

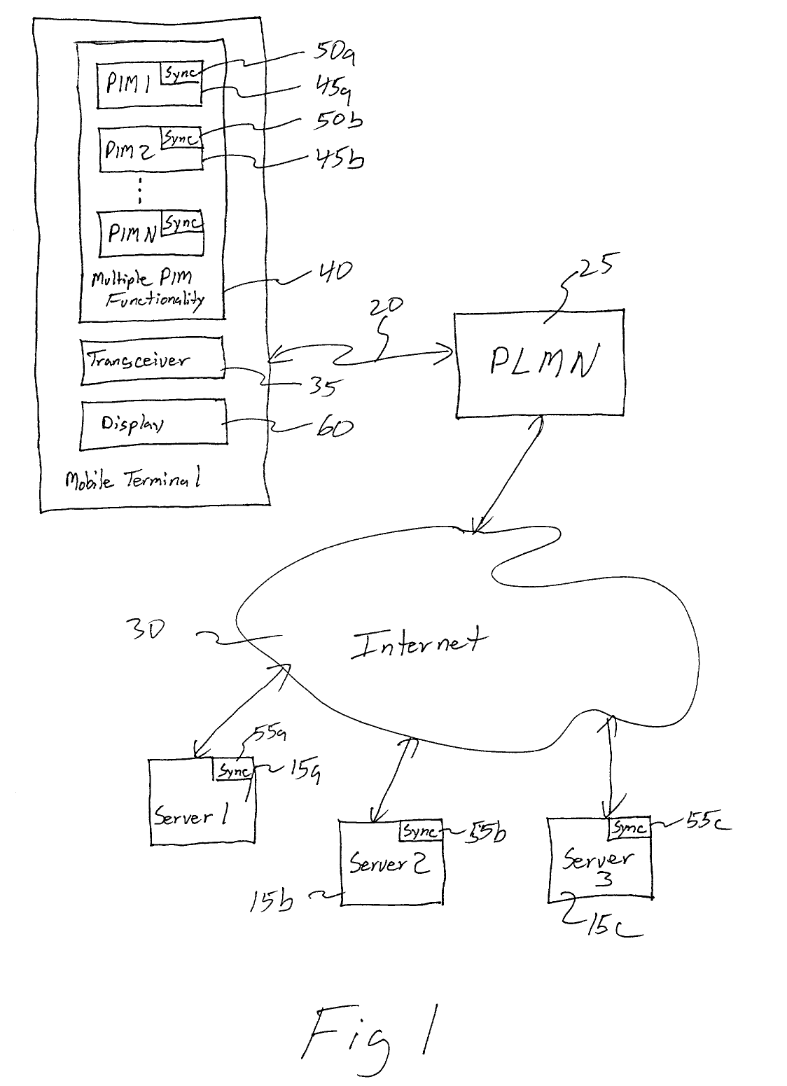

Referring now to FIG. 1, there is illustrated a mobile terminal 10 which can synchronize with a plurality of remote servers 15. Synchronization may occur using a wireless link 20 between the mobile terminal 10 and a network 25, for example, a PLMN, which provide access to the Internet 30. The wireless link 20 between the mobile terminal 10 and the PLMN 25 is supported by transceiver circuitry 35 within the mobile terminal 10. The mobile terminal 10 generates a synchronization link to the various remote servers 15 using the connection through the PLMN 25 and the Internet 30.

The mobile terminal 10 obtains synchronization with a plurality of remote servers 15 using the multiple personal information management (PIM) functionality 40. The multiple PIM functionality 40 includes a plurality of separate versions of a PIM application 45. Each of these versions of the PIM application 45 has the capability of synchronizing with a separate server 15. Each of the versions of the PIM application 45 includes separate synchronization data 50 enabling synchronization with the synchronization circuitry 55 included within each of the plurality of remote servers 15. The synchronization data 50a of a first version of the PIM application 45a enable this first version of the PIM application 45a to synchronize with the server 15a using synchronization circuitry 55a. Likewise, version 45b may use synchronization data 50b to synchronize with remote server 15b using synchronization circuit 55b. This process may continue with each version of the PIM application 45 synchronizing with a particular server 15.

The synchronization process enables data stored within the remote servers 15 to be downloaded to and displayed at the mobile terminal 35 on display 60. The data may be transferred in one embodiment using the vCalendar format, as described in “vCalendar—The Electronic Calendaring and Scheduling Exchange Format Version 1.0”, Sep. 16, 1996, which is incorporated herein by reference. The mobile terminal 35 interprets the data in vCalendar format and displays the data in the format of the mobile terminal. If, for example, the multiple PIM functionality 40 within the mobile terminal 10 included versions of a PIM application 45 for displaying a PIM calendar, the versions of the calendar application 45 would each be synchronized with a remote server such as YAHOO, MSN and Go.com. Data (i.e., dates) from each of these servers are downloaded and displayed on the display 60 of the mobile terminal 10. Each of the remote servers 15 include different content. For instance, the Go.com server would provide information about, for example, new movies by Disney, while the MSN server would provide information about Microsoft products. Other remote servers might provide local information about happenings in a user's hometown.

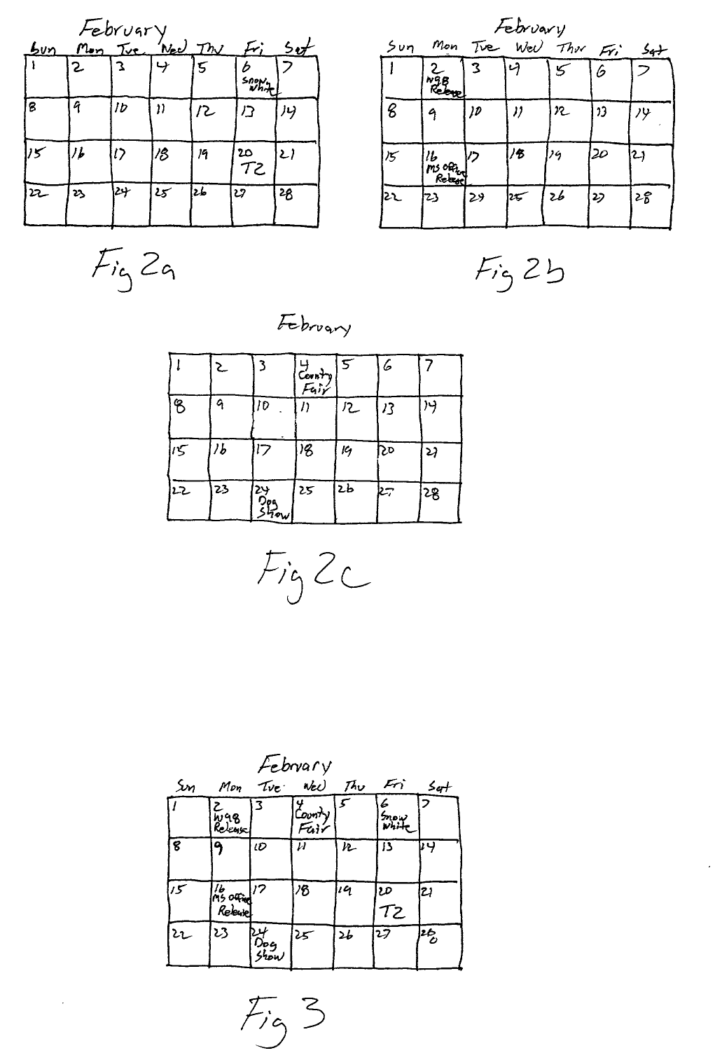

Referring now to FIGS. 2a-2c, there is provided one example of the manner in which the data may be displayed by the multiple PIM functionality 40. In FIGS. 2a-2c, the information from three different servers are displayed separately on three different screens of the mobile terminal 10. Thus, the information in FIG. 2a could be displayed on the display 60 of the mobile terminal 10 at one time then by clicking or requesting a next screen the information illustrated in FIGS. 2b and 2c would be displayed.

Alternatively, as illustrated in FIG. 3, the information from each of the remote servers 15 can be combined into a single unified display as illustrated. In this case, the calendar date information from the plurality of servers 15 are combined into a single calendar. Each of the three calendars could also be displayed together rather than displaying the data in a single calendar. A software program within the mobile terminal 10 combines the data into either of the described unified displays. It should be appreciated that while the discussion with respect to FIGS. 1, 2 and 3 have related to a PIM calendar functionality that any number of PIM applications may be utilized in accordance with the present invention.

Referring now to FIG. 4, there is illustrated a use of the present invention wherein a private calendar 100, which may be customized by a user to provide a desired look to the display and desired information on the display. The customization may be performed by a user via a PC interconnected with the mobile terminal 10 or directly on the mobile terminal 10. The information displayed in the portion of the calendar 100 shown in FIG. 4 is divided into private appointments 105, shown in bold (alternative indications such as highlighting, italicizing or coloring may also be used as an indication), and general appointments 110 which are non-bolded. The private appointments 105 might comprise meetings the user is to attend or other appointments personal to the user of the device containing the multiple PIM functionality 40. The general events 110 comprise information of a general nature of which the user might have an interest, for example, movies that are showing within the area, concert dates, festival dates and the like. Rather than having a private calendar 100 that is updatable by the user, the calendar may also be configured for informative purposes wherein the information is only displayed and is not manipulated or changed by the user.

The multiple PIM functionality 40 may have the calendar 100 set up such that a user's mobile terminal 10 would periodically download particular types of information which they desired to have stored on their calendar 100. For example, if the user were interested in movies, the user's calendar 100 could synchronize with a calendar providing movie information once a week. If the user were interested in concerts, the user's calendar 100 could synchronize once a month with the local symphony's website calendar. The user may predefine the servers with which their calendar 100 synchronizes and downloads.

The PIM functionality 40 may also be configured to provide updates if an event changes. For example, if a concert were canceled that the user had entered into their calendar, they would be provided with a special notification of the cancellation during a next synchronization. Also, if the user had downloaded particular information relating to their favorite television programs and a program were preempted or canceled for any reason, the user would be provided with an update of this change in the TV schedule during a next synchronization.

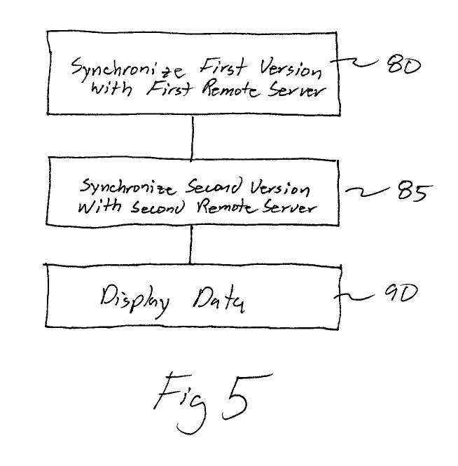

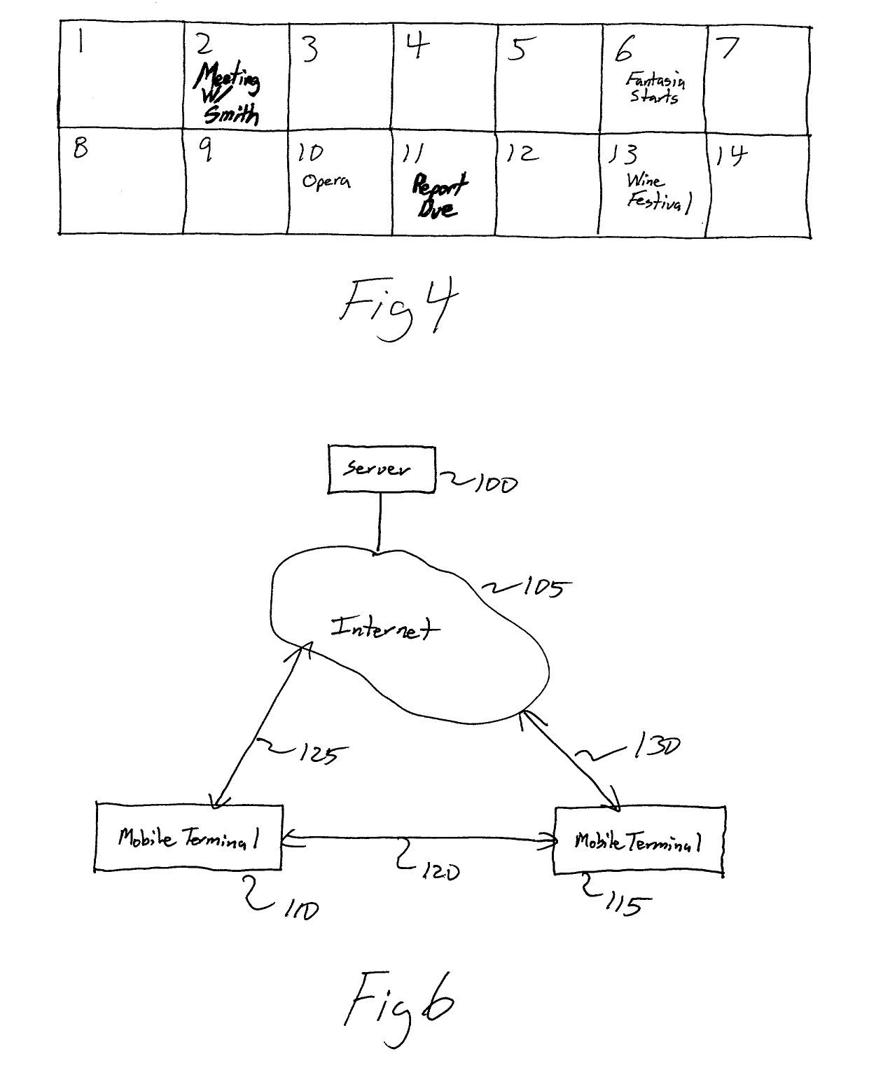

Referring now to FIG. 5, there is illustrated a functional block diagram of a method of operation of the system illustrated in FIG. 1. Initially, a first version of the PIM application 45a within the multiple PIM functionality 40 obtains synchronization at step 80 with a first remote server 15a. After synchronization has been obtained between a first version of the PIM application and a first remote server, a second version of the PIM application 45b obtains synchronization at step 85 with a second remote server 15b. This process may continue for as many PIM modules 45 and servers 15 as are available. Information obtained from the synchronization of the first PIM version 45a and second PIM version 45b are presented at 90 on the display 60 of the mobile terminal 10 in either the separated or unified form as discussed previously with respect to FIGS. 2 and 3.

Referring now to FIG. 6, there is illustrated an embodiment wherein data relating to, for example, a calendar, may be downloaded directly between a first mobile terminal 110 and a second mobile terminal 115 rather than from a remote server 100. In the example illustrated in FIG. 6, the mobile terminal 115 accesses data within mobile terminal 110 either directly via a communications link 120 using, for example, a PLMN telecommunications system, Bluetooth connection, infrared connection or any other wireline or wireless technology, or alternatively, may access the mobile terminal 110 via the Internet 105 using communications links 130 and 125.

Upon accessing the mobile terminal 110, the mobile terminal 115 may download data, for example, a calendar to provide access to all of the calendar data from mobile terminal 110. This information may then be stored within a calendar within the mobile terminal 115. Data from the remote server 100 may also be downloaded to either of the mobile terminals as described previously. Alternatively, the mobile terminal 115 may merely add data to the calendar within mobile terminal 110. This would involve uploading data from the mobile terminal 115. Provision of access by the mobile terminal 115 to the calendar data within mobile terminal 110 would be via some type of secure procedure which only enables access to the calendar data within the mobile terminal 110 by approved users.

The previous description is of a preferred embodiment for implementing the invention, and the scope of the invention should not necessarily be limited by this description. The scope of the present invention is instead defined by the following claims.

What is claimed is:

1. A mobile terminal, comprising:
a multiple PIM functionality module enabling the mobile terminal to synchronize with multiple remote servers and provide multiple groups of data with respect to a PIM application; and
transceiver circuitry for communicating with the multiple remote servers through a network;

2. The mobile terminal of claim 1, wherein the multiple PIM functionality module includes a plurality of versions of a PIM application, each of the plurality of versions of the PIM application able to synchronize with one of the multiple remote servers.

3. The mobile terminal of claim 2, wherein each of the plurality of versions of the PIM application includes separate synchronization data to enable synchronization with the multiple remote servers.

4. The mobile terminal of claim 1, wherein the multiple PIM functionality module provides for a separate display format of data from each of the multiple remote servers.

5. The mobile terminal of claim 4, wherein the separate display format is user selectable.

6. The mobile terminal of claim 1, wherein the multiple PIM functionality module provides for a unified display of data from each of the multiple remote servers.

7. The mobile terminal of claim 1, wherein the multiple PIM functionality displays a calendar containing the multiple groups of data.

8. The mobile terminal of claim 7, wherein the multiple groups of data may be displayed in bolded or non-bolded format depending on a relevance of the data.

9. The mobile terminal of claim 7, wherein the multiple PIM functionality enables selectable configuration of the calendar.

10. The mobile terminal of claim 1, wherein the multiple PIM functionality module further enables the mobile terminal to synchronize with a second mobile terminal.

11. A mobile terminal, comprising:
a multiple PIM functionality module including a plurality of versions of a PIM application, each version of the PIM application able to synchronize with one of a plurality of remote servers using synchronization data contained therein; and
transceiver circuitry for communicating with the plurality of remote servers through a wireless network.

12. The mobile terminal of claim 11, wherein the multiple PIM functionality module provides for a separate display format of data from each of the multiple remote servers.

13. The mobile terminal of claim 12, wherein the separate display format is user selectable.

14. The mobile terminal of claim 11, wherein the multiple PIM functionality module provides for a unified display of data from each of the multiple remote servers.

15. The mobile terminal of claim 11, wherein at least one version of the PIM application enables synchronization with a second mobile terminal.

16. A method of synchronizing a mobile terminal with a plurality of remote servers, comprising the steps of:
obtaining synchronization between a first portion of a PIM functionality and a first remote server to display data from the first remote server;
obtaining synchronization between a second portion of the PIM functionality and a second remote server to display data from the second remote server; and
displaying the data from the first and second remote servers on at least one display associated with the mobile terminal.

17. The method of claim 16, wherein the step of displaying comprises the step of selectively displaying data from either the first remote server or the second remote server responsive to user input.

18. The method of claim 16, wherein the step of displaying further comprises the step of displaying the data from the first and the second remote servers in a unified display.

19. The method of claim 16, wherein the step of displaying further comprises the step of displaying the data in a calendar.

20. The method of claim 19, wherein the step of displaying the data further comprises the step of displaying the data in a bold format and a non-bolded format depending on a type of the data.

21. The method of claim 16, wherein the step of displaying the data further comprises the step of displaying the data in the calendar in accordance with a selectable configuration of the calendar.

22. A mobile terminal comprising:
a multiple PIM functionality module enabling the mobile terminal to synchronize with multiple remote servers and display multiple groups of data from the multiple remote servers in a calendar; and
communication circuitry for communicating with the multiple remote servers.

23. The mobile terminal of claim 22, wherein the multiple groups of data may be displayed in bolded or non-bolded format depending on a relevance of the data.

24. The mobile terminal of claim 22, wherein the multiple PIM functionality enables selectable configuration of the calendar.

25. A method of synchronizing a mobile terminal with a second mobile terminal, comprising the steps of:
obtaining synchronization between a first portion of a PIM functionality and the second mobile terminal to display data from the second mobile terminal; and
displaying the data from the second mobile terminal on at least one display associated with the mobile terminal.

26. The method of claim 25, further including the steps of:
obtaining synchronization between a second portion of the PIM functionality and a remote server to display data from the remote server; and
displaying the data from the remote server on the at least one display associated with the mobile terminal.

27. The method of claim 25, further including the steps of:
uploading data from the mobile terminal to the second mobile terminal; and
displaying the data from the mobile terminal at the second mobile terminal.
